(19) United States
(12) Patent Application Publication
(10) Pub. No.: US 2007/0094524 A1
(43) Pub. Date: Apr. 26, 2007

(54) Using digital communications in the control of load sharing between paralleled power supplies

(75) Inventor: Bryan Kris, Phoenix, AZ (US)

Correspondence Address: BAKER BOTTS, LLP, 910 LOUISIANA, HOUSTON, TX, 77002-4995, US

(73) Assignee: Microchip Technology Incorporated

(21) Appl. No.: 11/385,377

(22) Filed: Mar. 21, 2006

Related U.S. Application Data
(60) Provisional application No. 60/729,998, filed on Oct. 25, 2005.

(51) Int. Cl. G06F 1/00

(52) U.S. Cl. 713/300

(57) ABSTRACT

A plurality of power supply modules having their outputs coupled in parallel are controlled for load balancing purposes through a digital communications channel. The digital communications channel may be a wired digital serial or parallel bus, and/or a wireless digital communications channel such as Bluetooth, infrared, etc. Each of the plurality of power supply modules may broadcast their respective output currents and all of the plurality of power supply modules may determine a total current supplied to a load and thereby determine an appropriate output voltage for proportionally contributing to the total current.

### RELATED PATENT APPLICATION

This application claims priority to commonly owned U.S. Provisional Patent Application Ser. No. 60/729,998; filed Oct. 25, 2005; entitled “Using Digital Communications in the Control of Load Sharing Between Paralleled Power Supplies,” by Bryan Kris; which is hereby incorporated by reference herein for all purposes.

### TECHNICAL FIELD

The present disclosure relates to control of load sharing between paralleled power supplies, and more particularly, to using digital communications in the control of load sharing between the paralleled power supplies.

### BACKGROUND

Many large electronic systems, e.g., compute servers, disk storage arrays, telecommunications installations, etc., require large amounts of operating power and this operating power must be highly reliable. A common approach for system designers is to implement a system power supply as a plurality of smaller power supply modules. The outputs of the plurality of smaller power supply modules are connected together in parallel to provide the operating power required. Usually there are more power supply modules in the system power system than required to supply the existing load. This arrangement enables removal (e.g., unplugging) of faulty power supply modules while the electronic system is operational and may not impact the operation thereof. Replacement power supply modules, e.g., new or repaired, may be plugged back into the system power supply to maintain a desired amount of redundant power supply capacity.

When the power supply module outputs are connected in paralleled, it is impossible to insure that each parallel connected power supply module has the same output voltage. There are always tolerances in wiring, voltage references, temperatures, and other factors that may cause the output voltages to differ slightly between the power supply modules. Therefore one or more of the power supply modules having a slightly higher output voltage, will tend to supply the bulk of the system load. Therefore, some of the power supply modules may be operating at full power while others may be providing almost no power. The power supply module operating at full power will be hotter and therefore more failure prone. The power supply modules that are operating at full power are “saturated” and can not supply additional power if there is a load transient. Also, the other power supply modules that are supplying little or no power may not be operating in an ideal state for a switch mode converter power supply. A lightly loaded power supply module may not have a desired response to a transient load. For optimum reliability and performance, each of the power supply modules should carry an evenly distributed share of the system load.

Attempts at achieving an evenly distributed share of the system load between the power supply modules has been implemented by using analog signaling. For example, a “master” device (controller) may monitor the total load and then may issue analog commands to each of the power supply modules in an effort spread the workload evenly among these power supply modules. The master control device may provide a voltage that represents a target power output goal for each power supply module. This master control device control voltage to each of the modules may be an analog voltage that may be used to adjust the power supply module's reference voltage and thereby may adjust the resultant output power from the module. This type of power flow signaling control may be prone to a single point failure. If the master controller fails, the power supply system may become unusable and/or inoperative. Another example is when an analog bus (wire) is connected to all of the power supply modules. Each power supply module provides an analog voltage output signal that is proportional to the power output of that module. These analog “power level” indicating voltages are summed together to create an average voltage on the analog bus (wire). Each module then reads the summed analog value and increases or decreases its output power to be consistent with the consensus of the group of modules.

These existing power load sharing control implementations require analog circuitry to create the load balancing signals, require circuitry to sum these signals onto the analog “bus,” and require analog circuitry to either read the analog sum voltage and/or process it, either an analog-to-digital converter (ADC), and/or an operational amplifiers (“op amps”), depending on the power supply design. The analog bus that shares load information between the power supply modules may be susceptible to noise.

Most modern technology power supplies use switching regulators that are controlled with digital circuits. In order to generate an analog control signal, a digital-to-analog converter (DAC) is needed to create the analog power indication signal, and an ADC may be required to convert the analog control signal to digital values. DACs may be large and expensive, as are op-amps, ADCs, and other analog circuits such as accurate voltage references.

### SUMMARY

Therefore there is a need for a purely digital approach for implementing load balancing (e.g., load sharing) of parallel connected power supply modules. Digital communication modules such as, for example but not limited to, an I²C module, a UART module, a SPI module and the like are small and inexpensive implementations of serial digital communications devices. Any of these serial communications devices may be interconnected with similar communication devices to create a digital communications channel that may be integrated with the power supply modules. The digital communications channel may provide a means for the various power supply modules to share their output loads and other information. Thus each power supply module may control its power output based upon the system load information received, e.g., the sum of the output currents of each of the power supply modules, the number of operational power supply modules, etc. The load sharing information enables the assembly of these power supply modules to be connected together in a manner where they may proportionally share the burden of the system load. If one or more of these power supply modules should fail then the other remaining functional power supply modules may dynamically adjust their output currents to make up for the loss in available current that had been previously supplied by the failed power supply module or modules.

It is contemplated and within the scope of this disclosure that any type of serial, parallel, and/or wireless, e.g., Bluetooth, infrared, etc., digital communications channel or channels may be used to convey each of the power supply modules' actual output current, maximum current output capability, operational status, control, etc. Also the digital communications channel may be coupled to a digital system, e.g., computer server, for administrator system management, control and/or status reporting for each of the power supply modules. Total available current from the operational power supply modules may be used by, for example but not limited to, system administration software when configuring and/or controlling the digital system power usage, e.g., if enough of the power supply modules are out of service (e.g., not enough power capacity), then the system management software may shutdown or idle various digital system loads so as not to exceed a maximum available power capacity from the power supply system (e.g., the functional parallel connected power supply modules).

Broadcasts over the digital communications channel from each of the power supply modules may be received by all of the power supply modules and may comprise, but are not limited to, power output levels of each of the power supply modules, e.g., power levels as a percentage of maximum power for each module. All of the power supply modules may receive these broadcasts and may use a running sum filter to create an average power level. Each power supply module may then adjust its power output to reach the desired goal of a proportional power output.

The power output adjustment, e.g., balancing, process may occur slowly. The control loop for this adjustment process may operate on a thermal time constant basis. Therefore the response time may be, for example but not limited to, about a second. Assuming the communication modules (I²C, SPI, UART, etc.) may operating at 100 KHz, and a single byte of data is transmitted, a byte would take about 200 microseconds. If a power supply system is comprised of 24 power supply modules (a large power supply system), then 4.8 milliseconds would be required for all of the power supply modules to broadcast. If a broadcast rate of 10× of the minimum required rate is provided to insure immunity to noise, the total time to send status packets would be 48 milliseconds per second. Thus the bus utilization would only be about 5 percent. Such a low bus utilization may minimize any bus collisions of from the power supply modules.

For example, each power supply module may broadcast a data value every 100 millisecond to all of the other power supply modules. The data may be in a format where a data value of 00 (hexadecimal) indicates a module is supplying 0% output power, and a value of (FF) indicates the power supply module is supplying 100% of it rated output power. Each module may receive all of the status packets, and perform a running sum average of all of the status values. The running sum average value may then be used to adjust the power output of each power supply module. Status and/or identity of each of the power supply modules may also be broadcast so that the number of available power supply modules and their maximum available capacity may also be recognized. This may also be advantageous for system management software and remote administrator system management. Using digital information for load balancing/sharing between power supply modules enhances the accuracy of the information and may provide better repeatable behavior at a lower cost as compared to present analog methods.

According to a specific example embodiment of the present disclosure, a power supply system may comprise a plurality of power supply modules, each of the plurality of power supply modules having an output coupled in parallel and a digital interface for communicating with each of the plurality of power supply modules, wherein each of the plurality of power supply modules has a digital controller using information supplied over the digital interface for controlling a voltage at the output thereof.

### BRIEF DESCRIPTION OF THE DRAWINGS

A more complete understanding of the present disclosure thereof may be acquired by referring to the following description taken in conjunction with the accompanying drawings wherein:

FIG. 1 illustrates a schematic block diagram of a plurality of power supply modules having their outputs connected in parallel and using digital communications for supplying information to each of the power supply modules in determining parameters for load sharing, according to a specific example embodiment of the present disclosure.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION

Referring now to the drawings, the details of specific example embodiments are schematically illustrated. Like elements in the drawings will be represented by like numbers, and similar elements will be represented by like numbers with a different lower case letter suffix.

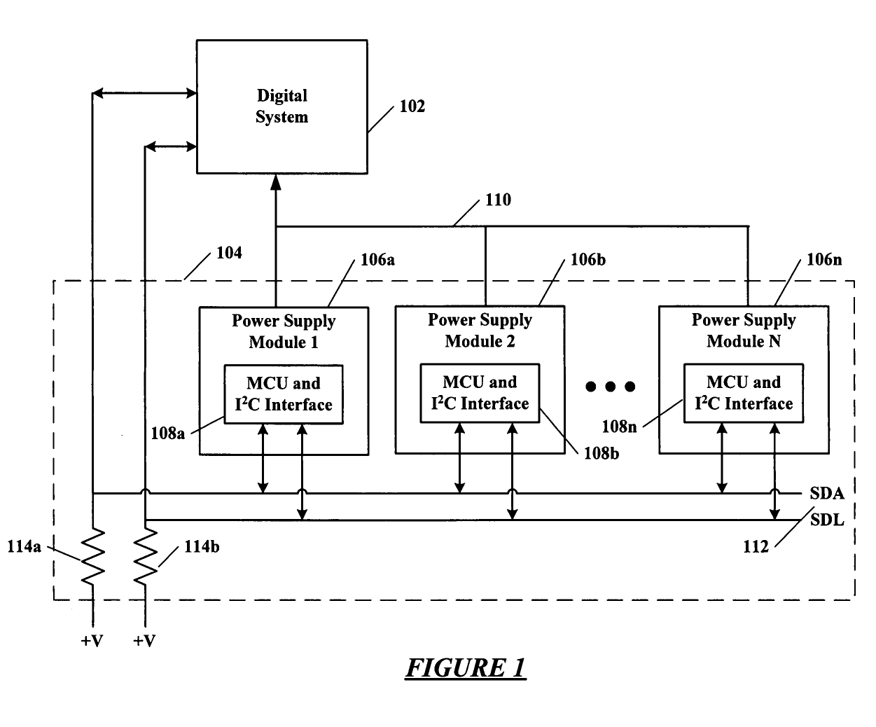

Referring to FIG. 1, depicted is a schematic block diagram of a plurality of power supply modules having their outputs connected in parallel and using digital communications for supplying information to each of the power supply modules in determining parameters for load sharing, according to a specific example embodiment of the present disclosure. A digital system 102, e.g., computer server, may be powered from a power supply system 104. The power supply system 104 may be comprised of a plurality of power supply modules 106. Each of the plurality of power supply modules 106 may have its power output coupled to a power bus 110. The power bus 110 is also coupled to the digital system 102. The power bus 110 may have more then one operating voltage (not shown) thereon.

Each of the plurality of power supply modules 106 may have a microcontroller and digital communications module 108. The digital communications module 108 may have a digital serial interface, e.g., I²C, UART, SPI, USB, etc. The digital communications module 108 may have a digital parallel interface. And/or the digital communications module 108 may have a wireless digital interface, e.g., Bluetooth, infrared, etc. All load sharing, power output, power supply module status and the like may be broadcast transmitted in a digital format. A digital format is much less susceptible to noise, and signal and component tolerances. Also the digital format does not require large, power consuming analog devices, e.g., ADC, DAC, voltage references and the like.

Shown in FIG. 1 is a standard serial communications protocol I²C bus 112. The I²C bus 112 may use two lines (wires) called SDA (Serial Data) and SCL (Serial Clock). Each of these two wires may be connected to all of the digital communications modules 108. In addition, I²C bus 112 may be coupled to the digital system 102. The SDA and SCL lines may be pulled up to +V by pull-up resistors 114, and may be individually pulled down to ground by any of the digital communications modules 108. The digital system may also communicate with the plurality of power supply modules 106 over the I²C bus 112.

Each of the plurality of power supply modules 106 may periodically broadcast to all of the other plurality of power supply modules, (typically every 100 milliseconds), for example a packet of information that indicates the power output level for the power supply module making the broadcast. Each of the other power supply modules may receive that broadcast and may maintain a list of the most recent “M” broadcast power levels. (Where M is a parameter chosen by the power supply module manufacturer). Each controller in a respective power supply module 106 may calculate an average value for the most recent “M” broadcast values. That averaged value represents the target output power level for all of the power supply modules 106. Those power supply modules 106 whose output power level is above the average may reduce their output voltage very slightly to reduce the output current delivered to the load, while other power supply modules 106 who are outputting less power than the average may raise their output voltage slightly to increase their delivered current to the load.

If a power supply module 106 should fail, the other remaining operational power supply modules 106 may determine the occurrence of the failed power supply module 106 and adjust their output voltages accordingly so as to maintain a required power output to the connected digital system 102. Some of the power supply modules 106 may have greater capacity then other ones of the power supply modules 106, either by manufactured size or output capacity change do to a local malfunction, e.g., over-temperature, loss of power components, etc. According to the present disclosure, automatic adjustment of the plurality of power supply modules 106 may take place to compensate for any change in status of a malfunctioning or a removed (out of service) power supply module 106. The digital system 102 may also be apprised of what is happening with the plurality of power supply modules 106 and may make exception reports to a administrator systems management program and/or modify operation of the digital system 102 if there may not be sufficient power available from the power supply system 104.

It is contemplated and with the scope of the present disclosure that a malfunctioning power supply module 106 may be removed from service and the remaining power supply modules 106 may continue operation without interruption to the digital system 102.

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

What is claimed is:

1. A power supply system, comprising:
a plurality of power supply modules, each of the plurality of power supply modules having an output coupled in parallel and a digital interface for communicating with each of the plurality of power supply modules, wherein each of the plurality of power supply modules has a digital controller using information supplied over the digital interface for controlling a voltage at the output thereof.

2. The power supply system according to claim 1, wherein the information comprises output current from each one of the plurality of power supply modules.

3. The power supply system according to claim 1, wherein each of the controllers calculates a sum of all currents from the outputs of the plurality of power supply modules and uses the sum in determining the voltage at the output of the respective one of the plurality of power supply modules.

4. The power supply system according to claim 1, wherein each one of the digital interfaces are coupled to a digital serial communications bus.

5. The power supply system according to claim 1, wherein the digital serial communications bus is an I²C bus.

6. The power supply system according to claim 1, wherein the digital serial communications bus is a SPI bus.

7. The power supply system according to claim 1, wherein each one of the digital interfaces are coupled to a digital parallel communications bus.

8. The power supply system according to claim 1, wherein each one of the digital interfaces are digital wireless interfaces.

9. The power supply system according to claim 1, wherein the digital wireless interfaces are Bluetooth interfaces.

10. The power supply system according to claim 1, wherein the digital wireless interfaces are infrared interfaces.

11. The power supply system according to claim 1, further comprising the digital interface coupled to a digital system and the parallel coupled outputs connected to the digital system.
